(19) United States
(12) Patent Application Publication
(10) Pub. No.: US 2023/0225373 A1
(43) Pub. Date: Jul. 20, 2023

(54) BEVERAGE COMPOSITIONS COMPRISING A CLOUDING AGENT

(71) Applicant: Firmenich SA, Satigny (CH)

(72) Inventors: Ding KANG, Shanghai (CN); Lei SHI, Shanghai (CN); Qiu-Min MA, Shanghai (CN); Fei ZHANG, Shanghai (CN)

(73) Assignee: Firmenich SA, Satigny (CH)

(21) Appl. No.: 18/002,456

(22) PCT Filed: Jul. 1, 2021
(86) PCT No.: PCT/EP2021/068213

§ 371 Date: Dec. 19, 2022

(30) Foreign Application Priority Data
Jul. 3, 2020 (WO) PCT/CN2020/100054
Aug. 12, 2020 (EP) 20190633.6

(51) Int. Cl. A23L 2/62; A23L 19/00

(52) U.S. Cl. CPC A23L 2/62; A23L 19/00

(57) ABSTRACT

The present invention relates to a beverage composition comprising a clouding agent selected from the group consisting of coacervate hydrocolloid particles comprising a protein and a polysaccharide, regenerated insoluble dietary fibers, partially soluble dietary fibers, emulsion stabilized by regenerated insoluble dietary fibers and/or partially soluble dietary fibers and any combination thereof, and optionally, one or more beverage ingredients as well as a beverage comprising the same and uses thereof.

### TECHNICAL FIELD

The present invention relates to a beverage composition comprising a clouding agent selected from the group consisting of coacervate hydrocolloid particles comprising a protein and a polysaccharide, regenerated insoluble dietary fibers, partially soluble dietary fibers, emulsion stabilized by regenerated insoluble dietary fibers and/or partially soluble dietary fibers and any combination thereof, and optionally, one or more beverage ingredients as well as a beverage comprising the same and uses thereof.

### BACKGROUND OF THE INVENTION

Clouding agents play an important role as food additive and are applied in beverages such as fruit juices or fruit-flavored beverages to impart inter alia turbidity and, thus, to achieve a more natural-looking and visually appealing beverage similar to fresh juice.

The food industry has traditionally used brominated vegetable oil and titanium dioxide as clouding agents. However, the use of brominated vegetable oil has been regulatory restricted and in some regions, e.g. in the European Union, completely banned from use as a food additive. Recently, the use of titanium dioxide has been banned as a clouding agent in beverages in many countries due to its potential health risks. Restrictions of these clouding agents resulted in a need to find a substitute beverage clouding agent. Natural clouding agents in turn are highly desired by consumers.

The food industry has also used fat-based emulsions as clouding agents. However, clouding agents based on fat develops an off taste, such as an undesirable rancid note due to the hydrolysis of the fat. Moreover, the presence of fat leads to further disadvantages such as clumping of the mixture or significantly decreased solubility of the mixture when reconstituted in water. A reduction of fat in turn reduces the fat intake by the consumers and can lead to prevention of the risk of obesity and diseases, which is associated with obesity, such as heart diseases and diabetes and specific types of cancer.

There is a need to provide beverage compositions comprising clouding agents for use in beverages that can impart stable turbidity in liquids, in particular in acidic as well as in neutral liquids. Moreover, there is a need to provide beverage compositions comprising clouding agents without imparting a strong off taste or any deleterious effect on flavor and which is based on natural compounds.

The present invention addresses these needs. In particular, the present invention provides beverage composition comprising clouding agents, which are natural and perform at least the same or even better than titanium dioxide and, additionally, can offer further health benefits.

### SUMMARY OF THE INVENTION

According to the first aspect, the present invention relates to beverage composition comprising a clouding agent selected from the group consisting of coacervate hydrocolloid particles comprising a protein and a polysaccharide, regenerated insoluble dietary fibers, partially soluble dietary fibers, emulsion stabilized by regenerated insoluble dietary fibers and/or partially soluble dietary fibers and any combination thereof, and optionally, one or more beverage ingredients. These beverage compositions might be in a dry form such as a powder or in a liquid form such as a suspension or a concentrated liquid such as a syrup.

In a second aspect, the present invention relates to a beverage comprising the beverage composition and a beverage base.

In a third aspect, the present invention relates to the use of a beverage composition comprising a clouding agent selected from the group consisting of coacervate hydrocolloid particles comprising a protein and a polysaccharide, regenerated insoluble dietary fibers, partially soluble dietary fibers, emulsion stabilized by regenerated insoluble dietary fibers and/or partially soluble dietary fibers and any combination thereof, and optionally, one or more beverage ingredients for providing a beverage with stabilized turbidity, in particular wherein at least 6%, 10%, 20%, 50% and preferably 90% of the initial level of the turbidity is maintained over a period of at least 24 hours, 48 hours and preferably 168 hours when used in a beverage.

### DETAILED DESCRIPTION OF THE INVENTION

Although the present invention will be described with respect to particular embodiments, the detailed description shall not to be construed in a limiting sense.

In the context of the present invention, the terms “about” and “approximately” denote an interval of accuracy that a person skilled in the art will understand to still ensure the technical effect of the feature in question. The term typically indicates a deviation from the indicated numerical value of ±20%, preferably ±15%, more preferably ±10%, and even more preferably ±5%. In particular, these terms indicate the exact value.

As used in this specification and in the appended claims, the used “%” or “wt. %” means “% by weight” unless otherwise indicated.

In a first aspect, the invention relates to a beverage composition comprising a clouding agent selected from the group consisting of coacervate hydrocolloid particles comprising a protein and a polysaccharide, regenerated insoluble dietary fibers, partially soluble dietary fibers, emulsion stabilized by regenerated insoluble dietary fibers and/or partially soluble dietary fibers and any combination thereof, and optionally, one or more beverage ingredients.

By “beverage composition” is understood a composition, which used in or applied to liquids resulting in a beverage, i.e. resulting in a drinkable liquid.

In the context of the present invention, the terms “liquid” or “beverage base” might be used interchangeable. The beverage base might be any liquid, in particular any drinkable liquid. In an embodiment, the beverage base is a neutral or an acidic liquid. In an embodiment, the beverage bas is a nonalcoholic beverage. In an embodiment, the beverage base is selected from the group consisting of water, such as table water or mineral water, juices such as fruit juices, vegetable juices, juice drink, nectar, smoothie or soft drinks such as lemonade or cola or fruit flavored sodas, infusion drinks, such as coffee, coffee substitutes, tea, or tea-like drinks, such as iced tea, fruit tea, herbal tea, rooibos, mate tea, lapacho; or milk or yogurt drinks; or mixed drinks, such as cocktails; liquors; energy drinks or isotonic drinks or health drinks, or functional beverages (e.g., nutraceuticals). In an embodiment, the beverage base is water. In another preferred embodiment, the beverage base is a juice.

According to the present invention, the beverage composition comprises a clouding agent. By “clouding agent” is understood an agent, which imparts turbidity in a liquid or increases turbidity in a slightly turbid or turbid liquid.

Turbidity in turn is described as the opaqueness of a liquid due to the presence of suspended solids or due to an emulsion and is measured in terms of nephelometric turbidity units (NTU). Methods of measuring turbidity are known in the art. Most turbidity monitors are based on the nephelometric method, which measures the amount of light scattered at right angles to an incident light beam by particles present in a sample. Measured values are indicated in nephelometric turbidity units, NTU. The basic instrument incorporates a single light source and a photodetector to sense the scattered light. Internal lenses and apertures focus the light onto the sample, while the photodetector is set at 90 degrees to the direction of the incident light to monitor scattered light. Other methods of measuring turbidity might be analyzation of liquids by using UV—visible spectrophotometer at a particular wavelength and by using turbidity-meter.

In the present invention, the turbidity values were measured using a Hach 2100N IS Laboratory Turbidimeter equipped with a LED light source (860±30 nm). Measurement range: 0-1000 NTU. Resolution: 0.001 NTU. The inside and outside of the sample cell were thoroughly cleaned and dried and then the solution was loaded to the cell near the top (˜30 mL). Each sample must be a uniform solution without bubbles or precipitates in the sample cell. The measured NTUs were average values of three replicates.

In an embodiment, the clouding agent is a natural clouding agent. The term “natural clouding agent” refers to a substance, which can be isolated from a natural product, such as a plant, a part of a plant, an animal or a part of an animal. Moreover, the isolate or the isolated clouding agent might be treated with acids or bases and in the context of the present invention is still considered as a natural clouding agent. The isolate is not considered a natural clouding agent in case it is chemically modified for example by means of derivatisations, such as for example halogenations, acetylations, esterifications, alkylations, silylations, cyclizations or carboxylations.

According to the present invention, the beverage composition may comprise coacervate hydrocolloid particles comprising a protein and a polysaccharide.

Coacervation is a phenomenon that produces coacervate colloidal droplets, wherein two liquid phases will co-exist: a dense, polymer-rich phase and a very dilute, polymer-deficient phase. By “coacervate hydrocolloid particle” is meant an organic-rich droplet formed via liquid-liquid phase separation. The phase separation is resulting from association of oppositely charged molecules, i.e. oppositely charged polyelectrolytes such as polysaccharides and proteins. Polysaccharides such as gum arabic or alginate might be understood as negatively charged polyelectrolytes. Proteins can be understood as positively charged polyelectrolytes.

The use of coacervate hydrocolloid particles as clouding agent is advantageous, since such coacervate hydrocolloid particles are stable in acidic as well as in neutral liquids, and are therefore applicable in both. In contrast thereto, clouding agents comprising aggregated proteins are typically not stable in a neutral environment.

In an embodiment, the beverage composition comprises coacervate hydrocolloid particles, wherein the protein of the coacervate hydrocolloid particles is a prolamin. Preferably, the prolamine is selected from the group of gliadin, secalin, avenin, hordein, zein, oryzin, kafirin, or any mixture thereof. Gliadin can be obtained from wheat, secalin can be obtained from rye, avenin can be obtained from oat, hordein can be obtained from barley, zein can be obtained from corn, oryzin can be obtained from rice, and kafirin can be obtained from sorghum.

In an embodiment, the beverage composition comprises coacervate hydrocolloid particles, wherein the protein of the coacervate hydrocolloid particles is selected from the group consisting of wheat protein, rice protein, pea protein, mung bean protein, whey protein and any combination thereof. Preferably, the protein of the coacervate hydrocolloid particles is whey protein. Preferably, the wheat protein is gliadin. Preferably, the rice protein is oryzin.

In an embodiment, the beverage composition comprises coacervate hydrocolloid particles, wherein the polysaccharide of the coacervate hydrocolloid particles is selected from the group consisting of pectin, carboxymethylcellulose, alginate, xanthan gum, gellan gum, gum arabic and any combination thereof. Preferably, the polysaccharide of the coacervate hydrocolloid particles is gum arabic. In case pectin is used as polysaccharide in the coacervate hydrocolloid particles, preferably low methoxyl pectin is used.

In an embodiment, the beverage composition comprises coacervate hydrocolloid particles, wherein the size of the coacervate hydrocolloid particles is from 0.5 to 5 μm, more preferably from 0.7 to 3 μm, still more preferably from 1 to 2 μm.

The particle size of the reconstituted powder in water was measured by Mastersizer 3000 (Malvern Instruments, Worcestershire, UK). The sample material and dispersant were set to be protein and water, respectively. All samples were measured without ultrasound and data (D[4,3]) were reported as average values of three measurements.

In an embodiment, the weight ratio of the protein to the polysaccharide in the coacervate hydrocolloid particles is from about 10:1 to 1:10, 3:1 to 1:8, 2:1 to 1:7, preferably 1:1 to 1:6, more preferably 1:2 to 1:5. In a particular embodiment, the weight ratio of the protein to the polysaccharide in the coacervate hydrocolloid particles is about 1:1, about 1:2, about 1:3, about 1:4, about 1:5, more preferably about 1:3.

In a preferred embodiment, the coacervate hydrocolloid particles comprise as a polysaccharide gum arabic and as a protein whey protein. The combination of this polysaccharide and protein is advantageous, since this coacervate hydrocolloid particles provides high stability of the particles in neutral and acidic liquids. Moreover, the turbidity in neutral and acidic beverages is improved. In particular, the proteins primarily provide turbidity by denaturation and aggregation of proteins. The polysaccharides are used as stabilizers to provide long-term stability of hydrocolloid particles. Furthermore, such a combination does not impart a deleterious flavor to the beverage.

In an embodiment, the clouding agent is a powder or granulate. Preferably, the clouding agent is provided as a powder. The clouding agent may be spray dried or obtained by recrystallization from a solution and subsequent filtration, optionally the solid is washed.

In an embodiment, a method of preparing a powdered clouding agent, which comprises a protein and a polysaccharide, comprises a) adding 1-10 wt % of a protein to 10-20 wt % of a polysaccharide in an aqueous suspension, b) mixing the suspension to obtain a solution, c) adjusting the pH of the solution to about 3.5 to 5.5, d) heating the solution to about 60 to 90° C., and e) spray drying the solution to form the powdered clouding agent.

According to the present invention, the beverage composition may comprise a regenerated insoluble dietary fiber.

Under a regenerated dietary fiber, a dietary fiber is understood whose original fiber structure has not been altered but that shows decreased crystallinity after regeneration. Decreased crystallinity can be determined e.g. by means of microscopy, X-ray diffraction measurement, or by Fourier transform infrared spectroscopy analysis.

In an embodiment, the regenerated insoluble dietary fiber is selected from the group consisting of lignin, cellulose, hemicellulose, chitin and any combination thereof. The regenerated insoluble dietary fiber is preferably chitin.

Chitin is the most common polysaccharide in nature besides cellulose and is used for structure formation. It differs from cellulose by an acetamide group and is a natural fiber, which is found in fungi as well as in articulata and molluscs. Regenerated chitin can be obtained by an acidic washing process, wherein a more natural clouding agent as modified starches, brominated vegetable oils or titanium dioxide can be achieved. Such regenerated chitin is suitable for food applications, since it is known not to be toxic.

In an embodiment, the regenerated insoluble dietary fiber is purified chitin. Purified chitin can be obtained by washing crude chitin powder, wherein the crude chitin powder is subjected to an alkali washing and acid washing processes. The resulting chitin residue can be washed to obtain purified chitin.

In an embodiment, the regenerated insoluble dietary fiber is regenerated chitin. Regenerated chitin can be obtained by a process, wherein a) the purified chitin is pre-wetted with deionized water, b) phosphoric acid and deionized water is added to the pre-wetted purified chitin and then mixed with phosphoric acid to obtain a homogenous suspension, c) the chitin suspension obtained is incubated in a shaking bath to obtain a clear solution, d) the solution is than diluted with deionized water to obtain a dispersion, e) the dispersion is centrifuged, f) the residue is washed with water to reach a constant pH value and regenerated chitin can be obtained.

According to the present invention, the beverage composition may comprise a partially soluble dietary fiber.

The term “partially soluble dietary fibers” refers to fibers, which are partially soluble in water, including soluble and insoluble fibers. In contrast thereto, soluble fibers completely dissolve in the solvent, as well as amount of fibers that can exist within the solvent such as water is high. Partially soluble dietary fibers dissolve if a small but still perceptible amount of the fiber is added, but they do not dissolve if too much is added. However, insoluble fibers do not or not in a perceptible way dissolve in solvent such as water. “Dietary fiber” consists of non-starch polysaccharides and other plant components such as cellulose, resistant starch, resistant dextrin, inulin, lignin, chitin, pectin, beta-glucan, and oligosaccharides. Dietary fibers can act by changing the nature of the contents of the gastrointestinal tract and by changing how other nutrients and chemicals are absorbed. Partially soluble fiber rich-diet are known to have an advantageous effect on the absorption and balance of calcium, magnesium, iron and zinc.

In an embodiment, the partially soluble dietary fiber is selected from the group consisting of sugar beet fiber, pea fiber, soybean dietary fiber, oat dietary fiber, wheat dietary fiber, citrus fiber or other dietary fiber and any combination thereof. The partially soluble dietary fiber is preferably a citrus fiber.

Citrus fiber of the invention can be obtained by process for preparing citrus fibers from citrus peel and/or pulp. The process may comprise treating citrus peel and/or pulp to obtain homogenized citrus peel and/or pulp; washing the homogenized citrus peel and/or pulp with an organic solvent to obtain organic solvent washed citrus peel and/or pulp; drying the organic solvent washed citrus peel and/or pulp; and recovering citrus fiber therefrom.

Citrus fiber has an excellent whitening and turbidity effect. Citrus fiber imparts stable turbidity in beverages, which are neutral or acidic. That citrus fiber imparts stable turbidity in beverages, which are neutral, has been shown in Example 3.

According to the present invention, the beverage composition may comprise an emulsion, wherein the emulsion is stabilized by regenerated insoluble dietary fiber and/or partially soluble dietary fibers.

Such a stabilized emulsion is also referred to “Pickering emulsion”. A Pickering emulsion is an emulsion that is stabilized by solid particles, which adsorb onto the interface between the two phases. If oil and water are mixed and small oil droplets are formed and dispersed throughout the water, the droplets may coalesce to decrease the amount of energy in the system. However, if solid particles are added to the mixture, they will bind to the surface of the interface and prevent the droplets from coalescing, making the emulsion more stable.

Common surfactant emulsifiers tend to be displaced by bile salts from the interface of the droplets during duodenal digestion. However, bile salts do not rashly displace particle-laden interfaces of Pickering emulsions during digestion and therefore hindering the ingestion of fat. Therefore, Pickering emulsions as clouding agent can lead to less fat intake and reduces obesity.

In an embodiment, the beverage composition comprises an emulsion, which is an oil-in-water emulsion.

In an embodiment, the oil fraction of the emulsion is less than 50 v/v %, preferably less than 40 v/v % and more preferably less than 30 v/v %. In a further embodiment, the oil fraction of the emulsion is in in an amount of 0.05 to 50 v/v %, 0.1-40 v/v %, 1-35 v/v %, preferably 5-30 v/v % and more preferably 10-20 v/v %.

In an embodiment, the oil is selected from the group consisting of olive oil, palm oil, soybean oil, canola oil (rapeseed oil), corn oil, peanut oil, sunflower oil and other vegetable oils. In a specific embodiment, the oil is sunflower oil.

In an embodiment, the water fraction of the emulsion comprises an amount of 0.6 to 10 wt. %, preferably 0.7 to 5 wt. %, more preferably 0.8 to 3%, still more preferably 1 to 2 wt. % of the regenerated insoluble dietary fiber or of the partially soluble dietary fiber.

The emulsion can be acidic or neutral. In an embodiment, the emulsion is neutral. In another embodiment, the emulsion is acidic.

In an embodiment, the beverage composition comprises an emulsion, wherein the emulsion is stabilized by regenerated chitin. In a further embodiment, the oil fraction of the emulsion stabilized by regenerated chitin is less than 40 v/v %, preferably less than 30 v/v % and more preferably less than 20 v/v %. In a further embodiment, the oil fraction of the emulsion is in an amount of 0.1-40 v/v %, 1-35 v/v %, preferably 5-30 v/v % and more preferably 10-20 v/v %. The emulsion can be acidic or neutral. In a preferred embodiment, the emulsion is neutral. In a preferred embodiment, the water fraction of the emulsion comprises an amount of 0.6 to 10 wt. %, preferably 0.7 to 5 wt. %, more preferably 0.8 to 3%, still more preferably 1 to 1.5 wt. % of the regenerated chitin.

In an embodiment, the beverage composition comprises an emulsion, wherein the emulsion is stabilized by regenerated citrus fiber. In a further embodiment, the oil fraction of the emulsion stabilized by regenerated citrus fiber is about 50 v/v %. In a further embodiment, the emulsion is acidic or neutral. In a preferred embodiment, the water fraction of the emulsion comprises an amount of 0.6 to 10 wt. %, preferably 0.7 to 5 wt. %, more preferably 0.8 to 3%, still more preferably 1 to 2 wt. % of the citrus fiber.

In a preferred embodiment, the beverage composition comprises an emulsion, wherein the emulsion is stabilized by a combination of regenerated chitin and citrus fiber.

In another embodiment, the beverage composition comprises a clouding agent, wherein the clouding agent is an emulsion powder.

In an embodiment, an emulsion powder can be prepared by drying an emulsion, wherein the emulsion is stabilized regenerated insoluble dietary fiber and/or partially soluble dietary fibers. In an embodiment, the emulsion powder is prepared by spray drying an emulsion. In another embodiment, the emulsion powder is prepared by freeze drying an emulsion.

In particular, the emulsion may be spray-dried preferably in the presence of a polymeric carrier material such as polyvinyl acetate, polyvinyl alcohol, dextrins, natural or modified starch, vegetable gums, pectins, xanthans, alginates, carragenans or cellulose derivatives to provide particles in a powder form.

In an embodiment, the emulsion powder comprises citrus fiber, sunflower oil and inulin. In another embodiment, the emulsion powder comprises regenerated chitin, sunflower oil and inulin.

TABLE 1
Ingredients of emulsion powders.

| Ingredients | Citrus fiber | Sunflower oil | Inulin | Total |
|---|---|---|---|---|
| Quantity (%) | 2.8 | 42.8 | 54.4 | 100 |
| | Regenerated | | | |
| Ingredients | chitin | Sunflower oil | Inulin | Total |
| Quantity (%) | 2.8 | 42.8 | 54.4 | 100 |

For example, the Pickering emulsion can be dried using the following spray drying method: The emulsion can be dehydrated by spray drying using a mini-spray dryer (B290, Büchi Labortechnik, Switzerland). The inlet and outlet temperatures were set at 190° C. and 90° C. with feed rate of 10 mL/min.

In a further embodiment, the clouding agent is any combination of the previously mentioned clouding agents. The clouding agent might be a combination coacervate hydrocolloid particles and regenerated insoluble dietary fibers. The clouding agent might be a combination of regenerated insoluble dietary fibers and partially soluble dietary fibers. Moreover, the clouding agent might be a combination coacervate hydrocolloid particles and regenerated insoluble dietary fibers and partially soluble dietary fibers. In an embodiment, the clouding agent comprises gum arabic and inulin. In a further embodiment, the clouding agent comprises gum arabic, inulin and gel particles. The gel particles may be oleogel particles. An oleogel particle is an organic gel particle. The gel particles may comprise oils and gelators.

By “beverage ingredient” it is meant an ingredient which can be usually used in beverages, such as thickeners, flavors, food colorings, nutrients, acid, acid salts, sweeteners, stabilizers, preservative or a combination thereof.

In an embodiment, the beverage ingredient is a flavor or fragrance. Flavors or fragrances might be any compound, which are typically used in beverages. By the term “flavor” it is herein understood a flavor or flavoring composition being a flavoring ingredient or a mixture of flavoring ingredients, solvents or adjuvants used for the preparation of a flavoring formulation, i.e. a particular mixture of ingredients, which is intended to be added to a drinkable composition to impart, improve or modify its organoleptic properties, in particular its flavor and/or taste. Flavoring ingredients are well known to a person skilled in the art and their nature does not warrant a detailed description here, which in any case would not be exhaustive, the skilled flavorist being able to select them on the basis of his or her general knowledge and according to the intended use or application and the organoleptic effect it is desired to achieve.

The flavoring ingredient may be a taste modifier. A “taste modifier” is understood as an active ingredient that operates on a consumer's taste receptors, or provides a sensory characteristic related to mouthfeel (such as body, roundness, or mouth-coating) to a product being consumed. Non-limiting examples of taste modifiers include active ingredients that enhance, modify or impart saltiness, fattiness, umami, kokumi, heat sensation or cooling sensation, sweetness, acidity, tingling, bitterness or sourness.

By the term “fragrance” it is herein understood a fragrance or fragrance composition being a fragrance ingredient or a mixture of fragrance ingredients, solvents or adjuvants used for the preparation of a fragrance formulation, i.e. a particular mixture of ingredients, which is intended to be added to a perfuming composition. Fragrance ingredients are well known to a person skilled in the art and their nature does not warrant a detailed description here, which in any case would not be exhaustive, the skilled perfumer being able to select them on the basis of his or her general knowledge and according to the intended use or application and the olfactive effect it is desired to achieve. Many of these fragrance and flavoring ingredients are listed in reference texts such as in the book by S. Arctander, Perfume and Flavor Chemicals, 1969, Montclair, N.J., USA, or its more recent versions, or in other works of similar nature such as Fenaroli's Handbook of Flavor Ingredients, 1975, CRC Press or Synthetic Food Adjuncts, 1947, by M. B. Jacobs, van Nostrand Co., Inc. Solvents and adjuvants of current use for the preparation of a fragrance or flavoring formulation are also well known in the industry.

In an embodiment, the beverage ingredient is a flavor. Typical flavors to be used in the beverage composition according to the present invention are flavors that are derived from or based on fruits where citric acid is the predominant, naturally-occurring acid include but are not limited to, for example, citrus fruits (e.g., lemon, lime), limonene, strawberry, orange, and pineapple. In one embodiment, the flavor is lemon, lime or orange juice extracted directly from the fruit. Further embodiments of the flavor comprise the juice or liquid extracted from oranges, lemons, grapefruits, limes, citrons, clementines, mandarins, tangerines, and any other citrus fruit, or variation or hybrid thereof. In a particular embodiment, the flavor comprises a liquid extracted or distilled from oranges, lemons, grapefruits, limes, citrons, clementines, mandarins, tangerines, any other citrus fruit or variation or hybrid thereof, pomegranates, kiwifruits, watermelons, apples, bananas, blueberries, melons, ginger, bell peppers, cucumbers, passion fruits, mangos, pears, tomatoes, and strawberries.

In a particularly preferred embodiment, the flavor is lemon or lime. In a further embodiment, the flavor comprises a citrus fruit, preferably lemon. In a particularly preferred embodiment, the flavor is limonene.

In an embodiment, the beverage ingredient is a food coloring. By the term “food coloring” it is herein understood a food coloring composition or a mixture of food coloring ingredients, solvents or adjuvants used for the preparation of a colored formulation, i.e. a particular mixture of ingredients, which is intended to be added to a drinkable composition to impart, improve or modify its optic properties, in particular its color. Food coloring or color additive is any dye, pigment or substance that imparts color when it is added to the beverage. Food coloring is added to make the beverage more attractive, appealing, appetizing or to prevent color loss due to exposure to light, air, temperature extremes, moisture and storage conditions. The food coloring might be natural or synthetic. Coloring ingredients are well known to a person skilled in the art and their nature does not warrant a detailed description here, which in any case would not be exhaustive, the skilled person being able to select them on the basis of his or her general knowledge and according to the intended use or application and the optic effect it is desired to achieve. In an embodiment, the food coloring is one or more food coloring selected from the group consisting of curcumin, carotene, chlorophyll, amaranth, carmine, tartrazine, betanin, and capsanthin.

In an embodiment, the beverage ingredient is a nutrient. Essential nutrients are energy sources, some of the amino acids, a subset of fatty acids, vitamins and certain minerals. In a further embodiment, the beverage ingredient is a mineral or a salt. In another embodiment, the beverage ingredient is a mineral or a salt thereof selected from the group consisting of phosphorus, potassium, magnesium, sodium, calcium, magnesium, iron, zinc or any combination thereof. In another embodiment, the beverage ingredient is a vitamin selected from the group consisting of vitamin A, B, C, D, beta-carotene, riboflavin or any combination thereof. Other vitamins, which can be added to the beverage composition, include vitamin B6, niacin, and vitamin B12. Other suitable vitamins are known by the skilled in the art and can also be used.

In an embodiment, the beverage ingredient is an acid, acid salt or sweetener. According to a particular embodiment, the acid is a food grade acid. According to a preferred embodiment, the acid is selected from the group of citric acid, lactic acid, sorbic acid, phosphoric acid and mixtures thereof. According to a particular embodiment, the acid salt is a food grade acid salt. According to a preferred embodiment, the acid salt is selected from the group of consisting of sodium citrate, sodium lactate, sodium benzoate, sodium sorbate, sodium phosphate, potassium citrate, potassium sorbate, potassium phosphate, calcium phosphate and mixtures thereof. A sweetener according to the present invention relates to natural sweeteners or artificial sweeteners. According to a preferred embodiment, the sweetener according to the present invention relates to natural and artificial sweeteners except of mono- or disaccharides. According to a preferred embodiment, the sweetener is sucrose, maltodextrin, glucose, or fructose. According to a further embodiment, the sweetener is a low-glycemic sweetener. A low-glycemic sweetener has a glycemic index (GI) of 55 or less, preferably of 50 or less. According to a preferred embodiment, the sweetener is selected from the group consisting of stevia extracts, glycosylated derivatives of stevia extracts, sugars, sucralose, D-tryptophan, NHDC, polyols, stevioside, Rebaudioside A, thaumatin, mogrosides, monellin, neotame, aspartame, alitame, potassium acesulfame, saccharine, monoammonium glycyrrhizinate, calcium cyclamate, sodium cyclamate, sodium saccharin, potassium saccharin, ammonium saccharin, and calcium saccharin and mixtures thereof.

In an embodiment, the beverage ingredient is a stabilizer, a preservative or a combination thereof. In another embodiment, the stabilizer is selected from the group consisting of ester gum, sucrose acetate isobutyrate, Neobee oil, sugar alcohol, fructose and mixtures thereof. The preferred stabilizer is ester gum. According to a preferred embodiment, the sugar alcohol is selected from the group consisting of erythritol, isomalt, lactitol, maltitol, mannitol, xylitol and sorbitol and mixtures thereof, preferably erythritol and sorbitol and mixtures thereof, more preferably sorbitol. Preservatives might be any chemical or natural preservatives. Preservatives might be selected from the group consisting of sulfur dioxide, sodium benzoate, tartrazine, benzoic and/or sorbic acid and salts thereof and mixtures thereof. The preferred preservative is sodium benzoate. Further preservatives can also be used and are known by the skilled in the art.

In an embodiment, the weight ratio of clouding agent to beverage ingredient, preferably a flavor, is equal or less than about 0.01:1 to 30:1, preferably 0.1:1 to 10:1.

TABLE 2
Ingredients of a beverage.

| Ingredients | Amount (g) |
|---|---|
| Sugar | 23.75 |
| Citric Acid | 0.3125 |
| Calcium Lactate | 0.25 |
| Sodium Citrate | 0.125 |
| Vitamin C | 0.05 |
| Xanthan Gum | 0.025 |
| Beta-Carotene | 0.375 |
| Clouding agent | 0.6 |
| Flavor | 0.1 |
| Water | 174.4125 |
| Total | 200 |

In a particular embodiment, the beverage composition provides a stable turbidity when used in a beverage.

By “stable turbidity”, it is meant that turbidity is present over a certain period of time in a liquid. In particular, by “stable turbidity” is understood that turbidity is present over a certain period of time in a liquid, wherein the turbidity in the liquid is about equal or higher than in a titanium dioxide suspension, having a similar initial level of the turbidity. The “initial level” of the turbidity (t=0) is measured in terms of nephelometric turbidity units (NTU) directly after dispersion the clouding agent.

The turbidity is “stable”, if at least 6% of the initial level of the turbidity over a period of at least 24 hours is maintained, when used in a beverage. The “initial level” of the turbidity is measured in terms of nephelometric turbidity units (NTU) directly after suspending the clouding agent (t=0) and set to 100%. After a certain period of time, e.g. after 5 min, 1 h, 12 h, 24 h, 48 h or after 168 h the turbidity is measured again in terms of nephelometric turbidity units (NTU), with the same method. The percentage of turbidity can then be calculated.

The turbidity is preferably seen as “stable”, if at least 30%, 40%, 50%, 60%, 70%, 80%, or 90% of the initial level of the turbidity over a period of at least 24 hours is maintained, when used in a liquid. Moreover, the turbidity is preferably seen as “stable”, if at least 80% of the initial level of the turbidity over a period of 7 days is maintained, when used in a liquid.

Moreover, the turbidity is preferably seen as “stable”, if at least 65%, preferably 75%, more preferably 85% or 90% of the initial level of the turbidity over a period of 7 days is maintained, when used in a beverage.

In an embodiment, the beverage composition maintains at least 6%, 10%, 20%, 50%, 70% and preferably 90% of the initial level of the turbidity over a period of at least 24 hours, 48 hours and preferably 168 hours when used in a beverage. The initial level of the turbidity is measured in terms of nephelometric turbidity units (NTU) directly after suspending the clouding agent (t=0) and set to 100%. After a certain period of time, e.g. after 5 min, 1 h, 24 h, 48 h or after 168 h the turbidity is measured again in terms of nephelometric turbidity units (NTU), with the same method.

In an embodiment, the beverage composition may be provided in a dry form. The beverage composition might be in a powdered, granulated or tablet form. In a particular embodiment, the dry beverage composition is a powder or a granulate. In a more particular embodiment, the dry beverage composition is a powder. The beverage composition in powdered or granulated form can be prepared by several drying methods, such as spray drying, drum drying etc. In an embodiment, the beverage composition is prepared by spray drying. In another embodiment, the beverage composition is prepared by crystallization or a freeze-drying method.

In an embodiment, the beverage composition may be provided in a liquid form. The beverage composition might be in a concentrated liquid. Concentrated liquids might be selected from the group consisting of syrups, such as fountain syrups, squashes or cordials. The beverage composition might be a suspension.

In another aspect, the invention relates to a beverage comprising the beverage composition and a beverage base.

By “beverage base” any suitable liquid is meant. In an embodiment, the beverage base is water, such as table water or mineral water. The beverage base is preferably any juice such as fruit juices and vegetable juices, juice drink, nectar, or smoothie. The beverage base might also be any soft drink such as lemonade or cola or fruit flavored sodas. The beverage base can also be a hot drink or an infusion drink, such as coffee, coffee substitutes, tea, or tea-like drinks, such as iced tea, fruit tea, herbal tea, rooibos, mate tea, lapacho. The beverage base might be mixed drinks, such as cocktails. The beverage base might be milk or yogurt drinks. The beverage base might also be liquors, energy drinks or isotonic drinks. The beverage base might be health drinks, or functional beverages (e.g., nutraceuticals). Preferably, the beverage base is a nonalcoholic beverage base.

By “beverage” any drinkable liquid is meant. In this specification, the term “beverage” is used interchangeable with the term “liquid”. According to an embodiment, the beverage is a nonalcoholic beverage. In a further embodiment, the beverage might be water, such as table water or mineral water. In a preferred embodiment, the beverage might be any juice such as fruit juices and vegetable juices, juice drink, nectar, or smoothie. The beverage might also be any soft drink such as lemonade or cola or fruit flavored sodas. The beverage can also be a hot drink or an infusion drink, such as coffee, coffee substitutes, tea, or tea-like drinks, such as iced tea, fruit tea, herbal tea, rooibos, mate tea, lapacho. The beverage might be mixed drinks, such as cocktails. The beverage might be milk or yogurt drinks. The beverage might also be liquors, energy drinks or isotonic drinks. The beverage might be health drinks, or functional beverages (e.g., nutraceuticals).

In an embodiment, the beverage base is acidic or neutral.

By “acidic” is understood that a liquid or beverage base has a pH value of less than 7, preferably the pH value is between 0 and 6.9, more preferably the pH value is between 1 and 6.7, still more preferably the pH is in between 2.5 and 6.5, even more preferably the pH value is between 3 and 6.

By “neutral” is understood that a liquid or beverage base has a pH value of about 7. In an embodiment, the liquid having a pH value between 6 and 8, preferably between 6.5 and 8, and more preferably between 7 and 8, still more preferably between 7 and 7.5.

In an embodiment, the beverage is acidic or neutral.

By “acidic” is understood that a liquid or beverage has a pH value of less than 7, preferably the pH value is between 0 and 6.9, more preferably the pH value is between 1 and 6.7, still more preferably the pH is in between 2.5 and 6.5, even more preferably the pH value is between 3 and 6.

By “neutral” is understood that a liquid or beverage has a pH value of about 7. In an embodiment, the liquid having a pH value between 6 and 8, preferably between 6.5 and 8, and more preferably between 7 and 8, still more preferably between 7 and 7.5.

In an embodiment, the beverage comprises coacervate hydrocolloid particles, wherein the coacervate hydrocolloid particles are present in an amount of 0.01 to 10 wt. %, 0.02 to 5 wt. %, 0.05 to 3 wt. %, preferably 0.1 to 1.5 wt. %, and still more preferably 0.2 to 0.6 wt. % based on the total amount of the beverage. Coacervate hydrocolloid particles impart stable turbidity in neutral liquids and/or in acidic liquids.

In an embodiment, the beverage comprises one or more different coacervate hydrocolloid particles.

In an embodiment, the beverage comprises a regenerated insoluble dietary fiber, wherein the regenerated insoluble dietary fiber is present in an amount of 0.01 to 10 wt. %, 0.02 to 5 wt. %, 0.05 to 3 wt. %, or preferably 0.1 to 1.5 wt. %, based on the total amount of the beverage. Regenerated insoluble dietary fibers impart stable turbidity in neutral liquids and/or in acidic liquids.

In an embodiment, the beverage comprises a regenerated insoluble dietary fiber, wherein the regenerated insoluble dietary fiber might be a combination of several regenerated insoluble dietary fibers.

In an embodiment, the beverage comprises a partially soluble dietary fiber, wherein the partially soluble dietary fiber is present in an amount of 0.05 to 30 wt. %, 0.08 to 20 wt. %, or preferably 0.5 to 10 wt. %, based on the total amount of the beverage. Partially soluble dietary fibers impart stable turbidity in neutral liquids and/or in acidic liquids.

In an embodiment, the beverage comprises one or more different partially soluble dietary fibers.

In an embodiment, the beverage comprises an emulsion, wherein the emulsion is stabilized by regenerated chitin in an amount of 1 to 1.5 wt. %, based on the total amount of the beverage, and/or citrus fiber in an amount of 1 to 10 wt. %, based on the total weight of the beverage.

In an embodiment, the emulsion is an oil-in-water emulsion comprising an oil in an amount of 1 to 50 v/v %. In a further embodiment, the emulsion is an oil-in-water emulsion comprising an oil in an amount of 3 to 40 v/v %. In another embodiment, the emulsion is an oil-in-water emulsion comprising an oil in an amount of 5 to 30 v/v %. In a preferred embodiment, the emulsion is an oil-in-water emulsion comprising an oil in an amount of 10 to 20 v/v %.

In a further aspect, the invention relates to the use of a beverage composition comprising a clouding agent selected from the group consisting of hydrocolloid particles comprising a protein and a polysaccharide, regenerated insoluble dietary fibers, partially soluble dietary fibers, emulsion stabilized by regenerated insoluble dietary fibers and/or partially soluble dietary fibers and any combination thereof, and optionally, one or more beverage ingredients, for providing a beverage with stabilized turbidity, in particular wherein at least 6%, 10%, 20%, 50% and preferably 90% of the initial level of the turbidity is maintained over a period of at least 24 hours, 48 hours and preferably 168 hours when used in a beverage.

In a further aspect, the invention relates to a beverage, which is prepared by adding a beverage base to the beverage composition. Thereby a beverage with stabilized turbidity is provided, in particular wherein at least 6%, 10%, 20%, 50% and preferably 90% of the initial level of the turbidity is maintained over a period of at least 24 hours, 48 hours and preferably 168 hours.

The invention will now be described in further detail by way of the following examples. The examples are illustrative only and are not meant to limit the claims or embodiments described hereinabove.

In the present invention, the turbidity values were measured using a Hach 2100N IS Laboratory Turbidimeter equipped with a LED light source (860±30 nm). Measurement range: 0-1000 NTU. Resolution: 0.001 NTU. The inside and outside of the sample cell were thoroughly cleaned and dried and then the solution was loaded to the cell near the top (˜30 mL). Each sample must be a uniform solution without bubbles or precipitates in the sample cell. The measured NTUs were average values of three replicates.

### Example 1

15 g whey protein powder and 45 g gum arabic were dispersed in 240 g deionized water by stirring at ambient temperature and the pH of the dispersion was adjusted to 7.0 and kept under stirring for 5 to 8 h to ensure complete dissolution. Subsequently, the solution was adjusted to pH 4.75 using 1.0 N, 0.1 N, and/or 0.01 N hydrochloric acid solutions. Afterwards, the solution was subjected to heating at 85° C. for 20 min at 700 rpm agitation speed and subsequently, the solution was cooled down by ice/water bath. The solution was dehydrated by spray drying using a mini-spray dryer (B290, Büchi Labortechnik, Switzerland). The inlet and outlet temperatures were set to be 165 and 90° C. with feed rate of 10 mL/min. The obtained powder was re-dispersed in aqueous solution, having different pH values, i.e. 3, 4, 5 or 6, respectively.

The evolution of turbidity (indicated by Nephelometric Turbidity Unit—NTU) with time for particle assembled by whey protein and gum arabic or titanium dioxide dispersed aqueous solutions having different pH values was recorded in Table 3.

TABLE 3
Evolution of turbidity over the time of the liquid comprising
particles assembled by whey protein and gum arabic or titanium
dioxide have been measured. The particles or titanium dioxide
were dispersed in aqueous solutions having different pH values.

| | | | | | Titanium |
|---|---|---|---|---|---|
| | | | | | dioxide |
| | Particles assembled by whey protein and gum | | | | (TiO₂) |
| | arabic, 0.6 wt. % | | | | 0.02 wt. % |
| Duration | pH 6.0 | pH 5.0 | pH 4.0 | pH 3.0 | pH 6.0 |
| 0 | 542 | 538 | 619 | 739 | 700 |
| 15 h | 494 | 504 | 572 | 580 | 310 |
| 24 h | 485 | 496 | 560 | 546 | 305 |
| 48 h | 457 | 433 | 485 | 480 | 285 |
| 5 days | 437 | 361 | 359 | 225 | 280 |

In Example 1, several liquids at different pH values comprising coacervate hydrocolloid particles have been evaluated. The coacervate hydrocolloid particles, which comprise gum arabic and whey protein, have shown to impart turbidity, which is higher or at least comparable as titanium dioxide over a period of five days at different pH values, i.e. the pH of the liquids was pH=3, 4, 5 or 6, respectively. Moreover, it has also been shown that those coacervate hydrocolloid particles were stable for at least five days.

### Example 2

100 g of gluten was extracted in 70 v/v % ethanol (1.00 L) by stirring for 2 h followed by centrifugation at 9900 g during 12 min. The supernatant was collected and after a night's rest at 4° C., centrifuged for a second time (9900 g for 12 min) to remove any precipitated material.

Gliadin extract was poured into water at a 1:5 ratio under continuous stirring (440 rpm) at room temperature. After addition, the particle suspension was stirred for an additional 2 min and left unstirred overnight at room temperature before further analysis. The concentration of the gliadin particle suspension is 0.04% w/v %.

Low methoxyl pectin (LMP, 1.40 w/v %) solution was prepared by dissolving the LMP in water and stirring overnight. After dissolution, the pH of LMP solution was adjusted to pH 3.7. Freshly produced gliadin suspension (0.04 w/v %) was brought to the same pH (pH 3.7) using citric acid (1.0 M). After pH adjustment, the LMP solution was added to the gliadin particle suspension in the same volume.

The suspension was dehydrated by spray drying using a mini-spray dryer (B290, Büchi Labortechnik, Switzerland). The inlet and outlet temperatures were set to be 165 and 90° C. with feed rate of 10 mL/min. The obtained powder was re-dispersed in deionized water or citrate buffer (pH 3.7), respectively.

The evolutions of turbidity (indicated by Nephelometric Turbidity Unit—NTU) of a liquid over the time, wherein the coacervate of gliadin and LMP or titanium dioxide was dispersed in deionized water or citrate buffer (pH 3.7), was recorded in Tables 4 and 5.

TABLE 4
Evolutions of turbidity of a liquid over the time,
wherein coacervate of gliadin and LMP or titanium
dioxide was dispersed in deionized water.

| | | Titanium |
|---|---|---|
| | Coacervate of gliadin and | dioxide |
| | LMP | (TiO₂) |
| Time (h) | 0.5 w/v % | 0.02 w/v % |
| 0 | 1190 | 1103 |
| 6 | 1231 | 941 |
| 24 | 1267 | 681 |
| 96 | 1210 | 281 |

TABLE 5
Evolutions of turbidity of a liquid over the time,
wherein coacervate of gliadin and LMP or titanium
dioxide was dispersed in citrate buffer.

| | | Titanium |
|---|---|---|
| | Coacervate of gliadin and | dioxide |
| | LMP | (TiO₂) |
| Time (h) | 0.5 w/v % | 0.02 w/v % |
| 0 | 1016 | 1028 |
| 6 | 1048 | 986 |
| 24 | 1006 | 712 |
| 96 | 930 | 252 |

### Example 3

Chitin powder (20 g) was incubated in 200 ml 1 M NaOH in a shaking bath at 45° C. and agitation speed of 150 rpm. After 3 h, the chitin suspensions were filtered and the pellet was re-suspended into 200 ml 1 M NaOH. This alkali-washing process was repeated twice more to remove the residual protein and the resulting pellets were washed extensively with water until a constant pH was reached. Subsequently, 1 M HCl was used to wash the chitin pellet following the same protocol described above. The final pellets were repeatedly washed with water to achieve a constant pH value of about 4.2. The purified chitin was then freeze-dried.

Phosphoric acid and deionized water were equilibrated to 4° C. in a refrigerator before use. Purified chitin (3.00 g) was pre-wetted with 9 ml deionized water and then mixed with 150 ml 85% phosphoric acid to reach a homogenous suspension. The chitin suspension obtained was incubated in a shaking bath at 5° C. and agitation speed at 150 rpm for 12 h to obtain a clear solution. Deionized water (750 ml) was used to dilute the chitin solution and to obtain a milky dispersion, followed by centrifugation at 16,700 g for 15 min. The supernatant was discarded and the pellet was dialyzed with water to reach a constant pH value.

1) The regenerated chitin dispersion was diluted with deionized water or citrate buffer (pH 3.7) to obtain regenerated chitin dispersions with a series of concentrations, i.e. 0.1 wt. %, 0.2 wt. %, 0.3 wt. %, 0.4 wt. %, 0.5 wt. %, and 0.6 wt. %.
2) The regenerated chitin dispersion with the concentration of 0.6 wt. % was spray dried at inlet temperature of about 160° C. to produce a white flowable powder. The powder was re-dispersed in deionized water or citrate buffer (pH 3.7), obtaining a series concentrations of regenerated chitin dispersion, i.e. 0.1 wt. %, 0.2 wt. %, 0.3 wt. %, 0.4 wt. %, 0.5 wt. % and 0.6 wt. %.

The evolutions of turbidity (indicated by Nephelometric Turbidity Unit—NTU) of a liquid over the time, wherein the regenerated chitin or titanium dioxide was dispersed in deionized water or citrate buffer (pH 3.7), was recorded in Tables 6 and 7. Thus, regenerated chitin generated by the first described way was used to measure the data of Tables 6 and 7. However, there was no significant difference in the use of the different types of regenerated chitin.

TABLE 6
Evolutions of turbidity of a liquid over the time, wherein regenerated
chitin or titanium dioxide was dispersed in deionized water.

| | | | | | | | Titanium |
|---|---|---|---|---|---|---|---|
| | | | | | | | dioxide |
| | Regenerated chitin | | | | | | (TiO₂) |
| Days | 0.1 wt % | 0.2 wt % | 0.3 wt % | 0.4 wt % | 0.5 wt % | 0.6 wt % | 0.02 wt % |
| 0 | 155 ± 34 | 313 ± 48 | 452 ± 57 | 583 ± 58 | 814 ± 43 | 912 ± 55 | 995 ± 82 |
| 1 | 148 ± 37 | 291 ± 59 | 414 ± 64 | 562 ± 45 | 693 ± 77 | 858 ± 63 | 632 ± 97 |
| 2 | 145 ± 46 | 286 ± 36 | 414 ± 53 | 566 ± 87 | 692 ± 75 | 856 ± 94 | 581 ± 111 |
| 7 | 106 ± 32 | 273 ± 53 | 416 ± 24 | 557 ± 95 | 701 ± 86 | 862 ± 74 | 177 ± 78 |

TABLE 7
Evolutions of turbidity of a liquid over the time, wherein regenerated
chitin or titanium dioxide was dispersed in citrate buffer.

| | | | | | | | Titanium |
|---|---|---|---|---|---|---|---|
| | | | | | | | dioxide |
| | Regenerated chitin | | | | | | (TiO₂) |
| Days | 0.1 wt % | 0.2 wt % | 0.3 wt % | 0.4 wt % | 0.5 wt % | 0.6 wt % | 0.02 wt % |
| 0 | 181 ± 45 | 364 ± 59 | 523 ± 66 | 735 ± 81 | 887 ± 71 | 1009 ± 92 | 941 ± 121 |
| 1 | 173 ± 53 | 357 ± 47 | 495 ± 85 | 708 ± 73 | 798 ± 108 | 844 ± 115 | 534 ± 99 |
| 2 | 165 ± 64 | 357 ± 43 | 516 ± 61 | 672 ± 84 | 793 ± 90 | 865 ± 101 | 415 ± 105 |
| 7 | 134 ± 47 | 350 ± 35 | 524 ± 59 | 714 ± 77 | 826 ± 81 | 964 ± 132 | 129 ± 65 |

In Example 3, liquids with different pH values, i.e. pH=7 and pH=3.7 comprising regenerated insoluble dietary fibers have been evaluated. The liquids comprised regenerated chitin. Regenerated chitin has been shown to impart turbidity in a liquid, which is higher as titanium dioxide over a period of seven days. Suspensions of regenerated chitin had been provided in several concentrations, i.e. 0.1, 0.2, 0.3, 0.4, 0.5, and 0.6 wt. %. Moreover, it has been shown that the turbidity of the liquid imparted by regenerated chitin is stable for at least 7 days.

In contrast thereto, in comparative Example 7, chitin fibers, which have not been regenerated, have been evaluated in liquids having different pH values, i.e. pH=7 and pH=3.7. Such suspensions showed only low stability of the turbidity of the liquids over a period of 24 h compared to titanium dioxide.

### Example 4

0.5 g of citrus fiber powders were dispersed in an amount of deionized water to obtain citrus fiber dispersions with a series of concentrations, i.e. 1 wt. % and 1.5 wt. %.

The evolution of turbidity (indicated by Nephelometric Turbidity Unit—NTU) of a liquid over the time, wherein the citrus fiber or titanium dioxide was dispersed in deionized water, was recorded in Table 8.

TABLE 8
Evolutions of turbidity of a liquid over the time, wherein citrus
fiber or titanium dioxide was dispersed in deionized water.

| | | | Titanium |
|---|---|---|---|
| | | | dioxide |
| | Citrus fiber | | (TiO₂) |
| Time | 1 wt % | 1.5 wt % | 0.02 wt % |
| 0 | 2734 ± 235 | 3544 ± 397 | 1181 ± 152 |
| 5 min | 2704 ± 381 | 3534 ± 472 | 1181 ± 129 |
| 6 h | 486 ± 73 | 711 ± 110 | 1117 ± 185 |

Citrus fiber imparts stable turbidity in beverages, which are neutral or acidic (values not shown). Moreover, the stability of citrus fiber in a neutral liquid, i.e. deionized water, is even higher than in an acidic liquid. Citrus fiber imparts stable turbidity over a period of time of at least 6 h. Citrus fiber provides the best stability during a short time of 5 min in deionized water.

### Example 5

Regenerated chitin dispersion with the concentration of 1 wt. % was prepared by dilution with deionized water. 2.14 g, 1.25 g and 0.56 g of sunflower oil were mixed with 5 g of regenerated chitin dispersion, respectively, to obtain water-continuous emulsions with oil fraction 30%, 20% and 10% by ultrasonication at 60% pressure amplitude for 2 min in a cold-water bath. The generated emulsions were stable.

The original emulsions were diluted for two hundred times with deionized water. The evolution of turbidity (indicated by Nephelometric Turbidity Unit—NTU) of a liquid over the time of the emulsion or titanium dioxide dispersed in deionized water, was recorded in Table 9.

TABLE 9
Evolution of turbidity of a liquid over the time for diluted
emulsion or titanium dioxide dispersed in deionized water.

| | | | | Titanium |
|---|---|---|---|---|
| | | | | dioxide |
| | Oil fraction of original emulsion | | | (TiO₂) |
| Days | 10 v/v % | 20 v/v % | 30 v/v % | 0.02 wt % |
| 0 | 1145 ± 188 | 2384 ± 282 | 3628 ± 436 | 995 ± 82 |
| 1 | 1092 ± 147 | 1874 ± 196 | 2670 ± 354 | 632 ± 97 |
| 2 | 1340 ± 298 | 1688 ± 206 | 2260 ± 263 | 581 ± 111 |
| 7 | 520 ± 117 | 251 ± 73 | 153 ± 64 | 177 ± 78 |

In Example 5, the 10, 20 and 30 v/v % oil-in-water emulsions stabilized by regenerated chitin (1% in the water fraction) showed excellent stability of the turbidity over a prolonged period of time of up to 7 days.

In contrast thereto, in comparative Examples 8 and 9, chitin fibers, which have not been regenerated, had been used. Such emulsions showed low stability of the turbidity of the liquids compared to titanium dioxide.

### Example 6

0.5 g of citrus fiber was dispersed in an amount of deionized water or citrate buffer (pH 3.7) to obtain citrus fiber dispersions with a series of concentrations, i.e. 1%, 1.5% and 2%. 5 ml of sunflower oil was mixed with 5 ml of citrus fiber dispersion, respectively, to obtain water-continuous emulsions with oil fraction of 50% by ultrasonication at 60% pressure amplitude for 2 min in a cold-water bath. The generated emulsions were stable.

The original emulsions were diluted for eight hundred times with deionized water or citrate buffer (pH 3.7), respectively, and then ultrasonication at 60% pressure amplitude for 2 min in a cold-water bath. The evolution of turbidity (indicated by Nephelometric Turbidity Unit—NTU) with time for diluted emulsion or titanium dioxide dispersed in deionized water or citrate buffer were recorded in Tables 10 and 11.

TABLE 10
Evolution of turbidity of a liquid over the time for diluted
emulsions or titanium dioxide dispersed in deionized water.

| | | | | Titanium |
|---|---|---|---|---|
| | | | | dioxide |
| | Concentration of citrus fiber in original emulsion | | | (TiO₂) |
| Days | 1 wt % | 1.5 wt % | 2 wt % | 0.02 wt % |
| 0 | 1075 ± 153 | 1317 ± 248 | 1112 ± 195 | 995 ± 82 |
| 1 | 1186 ± 269 | 1444 ± 358 | 1159 ± 237 | 632 ± 97 |
| 2 | 924 ± 241 | 1123 ± 332 | 1045 ± 214 | 581 ± 111 |
| 7 | 1057 ± 257 | 1341 ± 345 | 1141 ± 310 | 177 ± 78 |

TABLE 11
Evolution of turbidity of a liquid over the time for diluted
emulsions or titanium dioxide dispersed in citrate buffer.

| | | | | Titanium |
|---|---|---|---|---|
| | | | | dioxide |
| | Concentration of citrus fiber in original emulsion | | | (TiO₂) |
| Days | 1 wt % | 1.5 wt % | 2 wt % | 0.02 wt % |
| 0 | 1139 ± 235 | 1365 ± 289 | 1370 ± 331 | 941 ± 97 |
| 1 | 602 ± 189 | 838 ± 224 | 812 ± 258 | 534 ± 69 |
| 2 | 475 ± 152 | 521 ± 168 | 483 ± 124 | 415 ± 75 |
| 7 | 79 ± 43 | 115 ± 52 | 158 ± 55 | 129 ± 53 |

In Example 6, a 50 v/v % oil-in-water emulsion stabilized by citrus fiber showed excellent stability over a period of time of 7 days, wherein the water fraction of the emulsion comprised 1, 1.5 or 3 wt. % citrus fiber. The emulsions have been shown to be stable in neutral liquids as well as in acidic liquids.

### Example 7 (Control 1)

0.5 g of chitin was dispersed in an amount of deionized water or citrate buffer to obtain chitin dispersions with a series of concentrations, i.e. 0.2 wt. %, 0.5 wt. %, 0.8 wt. %, 1 wt. %, 1.5 wt. % and 2 wt. %.

The evolutions of turbidity (indicated by Nephelometric Turbidity Unit—NTU) of a liquid over the time, wherein chitin or titanium dioxide was dispersed in deionized water or citrate buffer (pH 3.7) were recorded in Tables 12 and 13.

TABLE 12
Evolutions of turbidity of a liquid over the time, wherein chitin
or titanium dioxide was dispersed in deionized water.

| | | | | | | | | Titanium |
|---|---|---|---|---|---|---|---|---|
| | | | | | | | | dioxide |
| | | Chitin | | | | | | (TiO2) |
| Duration | | 0.2 wt % | 0.5 wt % | 0.8 wt % | 1 wt % | 1.5 wt % | 2 wt % | 0.02 wt % |
| 0 | | 334 ± 67 | 1109 ± 138 | 2039 ± 245 | 3077 ± 468 | 3128 ± 575 | — | 1181 ± 152 |
| 5 | min | 61.9 ± 23 | 104 ± 36 | 155 ± 43 | 145 ± 56 | 191 ± 79 | 208 ± 78 | 1181 ± 129 |
| 6 | h | 4.5 ± 3.8 | 6.8 ± 4.9 | 9.8 ± 5.5 | 12.6 ± 7.3 | 15.2 ± 9.6 | 11.2 ± 7.7 | 1117 ± 185 |
| 24 | h | 2.3 ± 1.6 | 3.5 ± 2.5 | 5.4 ± 4.7 | 6.0 ± 5.2 | 6.4 ± 5.0 | 11.4 ± 6.1 | 747 ± 96 |

TABLE 13
Evolutions of turbidity of a liquid over the time, wherein
chitin or titanium dioxide was dispersed in citrate buffer.

| | | | | | | | | Titanium |
|---|---|---|---|---|---|---|---|---|
| | | | | | | | | dioxide |
| | | Chitin | | | | | | (TiO2) |
| Duration | | 0.2 wt % | 0.5 wt % | 0.8 wt % | 1 wt % | 1.5 wt % | 2 wt % | 0.02 wt % |
| 0 | | 312 ± 71 | 630 ± 116 | 2195 ± 258 | 2224 ± 372 | 4084 ± 653 | — | 1017 ± 147 |
| 5 | min | 62.7 ± 34 | 101 ± 42 | 135 ± 58 | 159 ± 64 | 176 ± 82 | 182 ± 87 | 1008 ± 132 |
| 6 | h | 10.2 ± 5.3 | 9.6 ± 6.1 | 10.7 ± 6.3 | 12.8 ± 8.5 | 17.6 ± 10.8 | 17.2 ± 11.4 | 899 ± 156 |
| 24 | h | 5.3 ± 3.8 | 4.1 ± 3.7 | 6.9 ± 5.6 | 6.5 ± 5.3 | 8 ± 7.2 | 9.4 ± 7.5 | 612 ± 82 |

In comparative Example 7, chitin fibers, which have not been regenerated, have been evaluated in liquids with different pH values, i.e. pH=7 and pH=3.7. Such suspensions showed only low stability of the turbidity of the liquids over a period of 24 h compared to titanium dioxide.

### Example 8 (Control 2)

Chitin dispersion with the concentration of 1 wt. % was prepared by dispersing 0.5 g of chitin in 49.5 g of deionized water. 50 g, 33.3 g, 21.4 g, 12.5 g and 5.6 g of sunflower oil were mixed with 50 g of chitin dispersion respectively in order to obtain water-continuous emulsions with oil fraction of 50 v/v %, 40 v/v %, 30 v/v %, 20 v/v % and 10 v/v % by ultrasonication at 60% pressure amplitude for 2 min in a cold water bath. Nevertheless, emulsion cannot be constructed successfully by chitin.

### Example 9 (Control 3)

0.5 g of chitin fiber was dispersed in an amount of deionized water or citrate buffer (pH 3.7) to obtain chitin fiber dispersions with a series of concentrations, i.e. 1 wt. %, 2 wt. %, 3 wt. %, 4 wt. % and 5 wt. %. 5 ml of sunflower oil was mixed with 5 ml of chitin dispersion respectively in order to obtain water-continuous emulsions with oil fraction of 50 v/v % by ultrasonication at 60% pressure amplitude for 2 min in a cold-water bath. However, the emulsion construction was failed.

1. A beverage composition comprising
a clouding agent selected from the group consisting of coacervate hydrocolloid particles comprising a protein and a polysaccharide, regenerated insoluble dietary fibers, partially soluble dietary fibers, emulsion stabilized by regenerated insoluble dietary fibers and/or partially soluble dietary fibers and any combination thereof, and
optionally, one or more beverage ingredients.

2. The beverage composition according to claim 1, wherein at least 6% of the initial level of the turbidity is maintained over a period of at least 24 hours when used in a beverage.

3. The beverage composition according to claim 1, wherein the protein of the coacervate hydrocolloid particles is selected from the group consisting of wheat protein, rice protein, pea protein, mung bean protein, whey protein and any combination thereof.

4. The beverage composition according to claim 1, wherein the polysaccharide of the coacervate hydrocolloid particles is selected from the group consisting of pectin, carboxymethylcellulose, alginate, xanthan gum, gellan gum, gum arabic and any combination thereof.

5. The beverage composition according to claim 1, wherein the regenerated insoluble dietary fiber is selected from the group consisting of lignin, cellulose, hemicellulose, chitin and any combination thereof.

6. The beverage composition according to claim 1, wherein the partially soluble dietary fiber is a citrus fiber.

7. The beverage composition according to claim 1, wherein the emulsion is stabilized by regenerated chitin and/or citrus fiber.

8. A beverage comprising the beverage composition according to claim 1 and a beverage base.

9. The beverage according to claim 8, wherein the beverage base is acidic or neutral.

10. The beverage according to claim 8, wherein the coacervate hydrocolloid particles are present in an amount of 0.01 to 10 wt. % based on the total amount of the beverage.

11. The beverage according to claim 8, wherein the regenerated insoluble dietary fiber is present in an amount of 0.01 to 10 wt. %, based on the total amount of the beverage.

12. The beverage according to claim 8, wherein the partially soluble dietary fiber is present in an amount of 0.05 to 30 wt. %, based on the total amount of the beverage.

13. The beverage according to claim 8, wherein the emulsion is stabilized by regenerated insoluble dietary fiber in an amount of 1 to 1.5 wt. %, based on the total amount of the beverage, and/or partially soluble dietary fiber in an amount of 1 to 10 wt. %, based on the total weight of the beverage.

14. The beverage according to claim 8, wherein the emulsion is an oil-in-water emulsion comprising an oil in an amount of 1 to 50 v/v %.

15. (canceled)

16. The beverage composition according to claim 2, wherein at least 6% of the initial level of the turbidity is maintained over a period of at least 48 hours when used in a beverage.

17. The beverage composition according to claim 2, wherein at least 6% of the initial level of the turbidity is maintained over a period of at least 168 hours when used in a beverage.

18. The beverage composition according to claim 4, wherein the polysaccharide is gum arabic.

19. The beverage composition according to claim 4, wherein the size of the coacervate hydrocolloid particles is from 0.5 to 5 μm.

20. The beverage according to claim 9, wherein the pH of the beverage base is between 2 and 8.

21. The beverage according to claim 10, wherein the coacervate hydrocolloid particles is obtained from a coacervation process using gum arabic and whey protein.
